(19) United States
(12) Patent Application Publication
(10) Pub. No.: US 2007/0119140 A1
(43) Pub. Date: May 31, 2007

(54) PICK-UP DEVICE FOR AGRICULTURAL HARVESTING MACHINES

(76) Inventors: Christophe Gette, Tremery (FR); Lionel Hasse, Solgne (FR); Fabien Meaux, Metz (FR); Thierry Bonhomme, (US)

Correspondence Address: STRIKER, STRIKER & STENBY, 103 EAST NECK ROAD, HUNTINGTON, NY, 11743, US

(21) Appl. No.: 11/560,717

(22) Filed: Nov. 16, 2006

(30) Foreign Application Priority Data
Nov. 25, 2005 (DE) 10 2005 056 554.9

(51) Int. Cl. A01D 89/00

(52) U.S. Cl. 56/364

(57) ABSTRACT

A pick-up device for agricultural harvesting machines for picking up crop material lying on a ground has a pick-up drum which has tines; means selected from the group consisting of conveyor means, cutting means, and both and located adjacent to the pick-up drum in a direction of material flow; a compressing device extending transversely to a direction of travel of the agricultural harvesting machine within a range of action of the pick-up drum, the compressing device includes a first compressing element in the range of action of the pick-up drum and at least one further compressing device outside of the range of action of the pick-up drum, and a further compressing element causing the crop material to be precompressed onto the ground.

### CROSS-REFERENCE TO A RELATED APPLICATION

The invention described and claimed hereinbelow is also described in German Patent Application DE 10 2005 056 554.9 filed on Nov. 25, 2005. This German Patent Application, whose subject matter is incorporated here by reference, provides the basis for a claim of priority of invention under 35 U.S.C. 119(a)-(d).

### BACKGROUND OF THE INVENTION

The present invention relates to a pick-up device for agricultural harvesting machines and a compressing device which is located above it and extends transversely to the direction of travel of the agricultural harvesting machine.

This pick-up device, which is basically designed as a pickup or a rake-up, serves to pick up crop material—such as green crops laid down in swaths, straw or hay—from the field during travel, and to feed it to further processing units inside the agricultural harvesting machine.

A compressing device is assigned to pick-up device to limit the upward motion of the crop material when it is picked up from the field and to reliably feed it to the downstream processing units.

Publication DE 101 20 204 A1 makes known, e.g., a pick-up device with a generic compressing device. The compressing device is designed as a roller-type compressing device which extends transversely to the direction of travel. The roller-type compressing device is composed of two compressing rollers located one behind the other in the direction of material flow, and which are located in front of or partially above but within the range of action of the pick-up drum, and which serve to compress and guide material.

This results in an even flow of material under certain conditions, and harmonization of the crop-material flow inside the pickup. It is a disadvantage, however, that the motions of the two compressing rollers are coupled to each other. For example, when one of the compressing rollers is swivelled upward, the other compressing roller must also be swivelled upward. The conveyance and compression of material can be interfered with as a result.

A further compressing device is made known in U.S. Pat. No. 4,015,410, which includes a freely rotatable roller which is mounted on a vertically-displaceable frame of a baler. The frame rests on a cross-carrier; as such, the roller is kept close to the ground. In that case, the roller compresses the crop-material swath, which is on the ground, and, via a pick-up drum, forms a material-flow gap, by way of which the crop material is fed to the downstream processing units. The cross-carrier, which includes tines, also serves as a material-guidance element and as an upper limit for the crop material to be conveyed above the pick-up drum.

The disadvantage of this embodiment is that, when the height and density of the crop-material swath changes, it takes a great deal of pressure to deflect the compressing device upwardly due to the weight of the roller and the continually increasing swath height, and it pushes the crop material in front of it under certain conditions. The feed of crop material can be interrupted as a result. Furthermore, since it is mounted on the harvesting machine in a fixed and non-displaceable manner the material-guidance element, which is designed as a cross-carrier with tines, can serve as an upper limit for very large crop-material swaths; as such, the crop-material swath can decompress in the region of the roller—which acts as a compressing device—and the material-guidance element and downstream cutting and/or conveying units, where it can result in jams in the crop-material flow and, therefore, to further harvesting interruptions.

### SUMMARY OF THE INVENTION

The object of the present invention is to prevent the disadvantages described in the related art and, in particular, to attain continual material precompression and conveyance.

According to the present invention, the compressing device includes at least a first compressing element in the range of action of the pick-up drum and at least one further compressing element outside of the range of action of the pick-up drum. The further compressing element causes the crop material to be compressed against the ground. As a result, the crop material—which has been laid down in swaths—is advantageously homogenized and precompressed before it meets the pick-up drum. As a result, the crop material can be more easily picked up by the pick-up drum and fed to the downstream cutting/conveyance units.

The compressing device is preferably designed as a bar-type compressing device and/or a plate-type compressing device and/or a roller-type compressing device. These types of compressing devices are known on pick-up devices and—after having been adapted for the application of the agricultural harvesting machine—have proven to be particularly advantageous.

Given that at least one compressing device brings about a compression of the crop material against the pick-up drum, a reliable and continual flow of crop material inside the pick-up device is ensured via a simple design.

The compressing elements are advantageously movable relative to each other within a specified range of rotation, which is limited by guide elements which have upper and lower end stops. This advantageously enables the conveyance and compression of crop material to be maintained even when a compressing element must relinquish its optimal position for conveying and compressing crop material.

In an advantageous refinement of the present invention, the bearing pressure applied by the compressing elements on the crop material can be adjusted separately. As a result, the bearing pressure of the individual compressing elements can be adapted to the mass of crop material encountered, thereby permanently resulting in a homogeneous flow of crop material inside the pick-up device and preventing crop material from becoming jammed, thereby preventing harvesting interruptions.

Given that the compressing device is provided with at least one actuator for changing the bearing pressure applied by at least one compressing element on the crop material, the natural weight of the compressing device and the particular compressing element can be reduced, in order to reduce a hindrance to material flow or damage to the crop material by the compressing device, and to improve conveyance. The device for influencing the bearing pressure can be, advantageously, a device which is remote-controllable by the operator of the harvesting machine during the harvesting operation, so that the operator can adjust the desired bearing pressure at any time in accordance with the crop-material properties. The use of generally known pressure sensors has proven particularly advantageous, by way of which the adjustment of the bearing pressure of the compressing elements can be carried out automatically, to simplify operation for the operator of the harvesting machine.

In an advantageous refinement of the present invention, the design of the compressing device is selected such that a first compressing element is pivotably connected with the frame of the pick-up device and can compress the crop material against the ground. A further compressing element, which is movable relative to the first one, advantageously brings about a precompression of the crop material against the pick-up drum. Via this two-fold compression which the crop material undergoes on its way through the pick-up device, it is possible to feed the picked-up crop material swaths to downstream processing units in a homogeneous, constant, and interference-free manner.

Particularly suitable are compressing elements with material-guidance elements in the form of at least one bar and/or a plate and/or auger turns. These compressing elements can be mounted particularly advantageously on the side of the compressing element facing the crop material using a device which is located against the direction of crop-material flow and extends into the crop-material flow. A bar and/or plate positioned according to the present invention can also advantageously extend over the range of action of the compressing device and then continue to act on the crop material as it travels through the pick-up device. When the first compressing element and the compressing element which is movable relative thereto are designed as roller-type compressing elements with circumferential auger turns, this advantageously causes the crop material to move transversely to the material flow when it rolls over it, which also results in homogenization of the crop material which enters the draw-in region.

In an embodiment with a simple design and which can be manufactured cost-effectively, the material-guidance element can be designed as a compressing plate. The material-guidance element abuts, in the direction of flow of the crop material, a first compressing element, which is located outside the range of action of the pick-up drum and is designed as a compressing roller. To further improve the crop-material flow and to prevent the crop material from being lifted off of the conveying units, a bar grate composed of tines can abut the further compressing element, which is also designed as a compressing roller. These material-guidance elements can also be designed as compressing rollers; this allows the effect of the material-guidance elements to be advantageously adapted to the particular circumstances and properties of the crop material.

In a further advantageous embodiment of the present invention, at least one compressing roller of the compressing device is provided with a material-guidance element known per se, such as auger turns, and it is designed with different diameters, at least in certain areas. As a result, the circumferential speeds of the compressing rollers advantageously differ in certain areas, and the crop material is therefore conveyed transversely to the direction of material flow in the direction of the roller region with the smaller diameter.

The conveyance of material can be increased specifically by actively driving at least one compressing roller. A drive of this type also means the rotational speed can be set; this allows the effect of the material-guidance elements of a compressing roller to be adapted to the particular circumstances and properties of the crop material. In addition, drive control of the compressing roller which depends on driving speed can be advantageously realized. This means the crop material can be combined in a non-destructive manner.

Advantageously, at least one compressing roller of the compressing device drives at least one further compressing roller. This refinement of the present invention is used advantageously when the compressing device is designed with at least two compressing rollers. Via selection of the gear ratio of the drive, similar or different circumferential speeds of the compressing rollers can then be advantageously realized. This drive connection, in combination with material-guidance elements located on the compressing rollers, advantageously results in an increased transverse conveyance of the crop material, since, depending on the design of the drive connection, a speed differential between the speed of the crop material and the circumferential speed of a driven compressing roller can be produced.

Given that the compressing element which is suitable for compressing the crop material against the ground is fixable in an upper end position, if crop material becomes jammed inside the pick-up device, quick and easy access to the site of possible crop-material jams inside the pick-up device can be ensured.

The novel features of which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 shows a side view of a pickup with a roller-type compressing device in accordance with the present embodiment;

FIG. 2 shows a top view of the pickup shown in FIG. 1 in accordance with the present embodiment.

### DESCRIPTION OF THE PREFERRED EMBODIMENTS

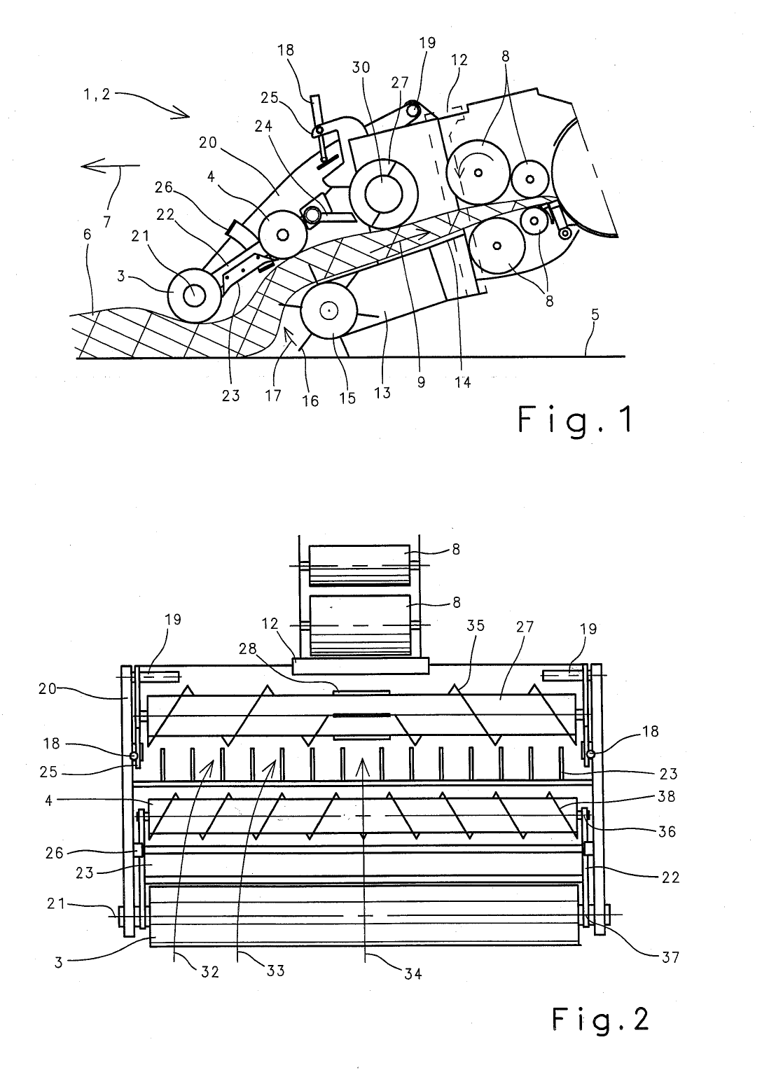

FIG. 1 shows an embodiment of a pick-up device 1 in the form of a pickup 2 with a roller-type compressing device 3, 4, 20, 22, 23, 24 in a longitudinal view near the middle of pick-up device 1. Pickup 2 shown picks up crop material 6 lying on ground 5, combines it and then transfers it—against direction of travel 7—to downstream intake rollers 8. Picked-up crop material 6 is conveyed through pickup 2 along material flow line 9 indicated. Pickup 2 is connected via a supporting frame 12 with the further working units of the agricultural harvesting machine. A carrier element 13 which is hingedly mounted on this supporting frame 12 extends in the direction of travel 7 of the agricultural harvesting machine.

On the top, this carrier element 13 forms a tub-shaped grain pan 14. A pick-up device, which is designed as a pick-up drum 15 in this case, is located on the front—in direction of travel 7—end of carrier element 13. This pick-up drum 15 extends transversely to direction of travel 7 across the entire width of pickup 2 and defines the pick-up width of pickup 2. Several not-shown tine carriers extend across the pick-up width on the circumference of pick-up drum 15; tine carriers include a large number of tines 16 which extend through the jacket surface of pick-up drum 15 around the circumference. These tine carriers with associated tines 16 are driven by the agricultural harvesting machine in direction of rotation 17. They lift crop material 6—which has been laid down in swaths—from ground 5 and convey it circumferentially along pick-up drum 15 to grain pan 14. Crop material 6 first undergoes a horizontal/vertical conveying motion, then a vertical conveying motion and, finally, an increasingly horizontal conveying motion.

To prevent crop material 6 from being lifted up along material-flow line 9 and to feed homogenized and pre-compressed crop material 6 to pick-up drum 15, compressing device 3, 4, 20, 22, 23, 24 shown is composed of two spacially separated compressing rollers 3, 4 located in material-flow direction 9. According to the present invention, first compressing roller 3 is located in front of and outside of the range of action of pick-up drum 15. This compressing roller 3 is hingedly mounted in a vertically displaceable manner in front of pick-up drum 15, as viewed in direction of travel 7, outside of the range of action of pick-up drum 15, and is free to rotate at both ends on a supporting segment 20, which is hingedly connected via a rotation point 19 with supporting frame 12. Compressing roller 3 advantageously compresses crop material 6 against ground 5.

Two supporting arms 22 which extend opposite to direction of travel 7 are hingedly mounted—such that they are vertically displaceable—directly in rotation point 21 at the front ends of particular supporting segment 20. A further compressing roller 4 is hingedly mounted—such that it is vertically displaceable—at both ends of particular supporting arm 22 partially in front of or above and within the range of action of pick-up drum 15. Further compressing roller 4 advantageously brings about a compression of the crop material against pick-up drum 15. Advantageously, a compressing plate 23 covers the open space between compressing rollers 3, 4, and a bar grate 24 covers the region from upper compressing roller 4 to at least the discharge side of the pickup. Due to the two-fold precompression, a homogenized crop-material flow inside pickup 2 can be advantageously attained.

According to the present invention, compressing rollers 3, 4 shown here are movable relative to each other within a specified range, so that compressing rollers 3, 4 bring about precompression of crop material 6 independently of each other. As a result, an adjustable mode of operation of particular compressing roller 3—which is not shown here—can be attained. Mechanical, hydraulic, or active actuating devices, for example, are suited for this purpose. As a result, the bearing pressure of compressing rollers 3, 4 can be advantageously adapted to crop-material properties, by way of which an even crop-material flow and harmonization of crop-material flow through pickup 2 can be attained.

Guide elements 25 which have lower and upper end stops on both sides are fixedly mounted on not-shown lateral elements of carrier element 13, and they are positioned at a right angle to supporting segment 20. In this manner, the potential vertical mobility of supporting segments 20—which accommodate a compressing roller 3 on their front ends—with respect to pick-up drum 15 and grain pan 14 is specified. According to the present invention, supporting segments 20 are fixable in their upper end position using fastening means known per se. If crop material 6 becomes jammed inside pick-up device 1, this allows rapid, easy access to the site of jams of crop material 6 inside pickup 2. An acutator 18 is assigned to guide element 25, by way of which the vertical displaceability of compressing device 3, 4, 20, 22, 23, 24 can be actively influenced to control the bearing pressure of compressing device 3, 4, 20, 22, 23, 24 on crop material 6.

Actuator 18 is preferably designed as a lifting cylinder which is known per se. Supporting segments 20 also include guide elements 26 on both sides on their outer edges and perpendicular to particular support arm 22, which include lower and upper end stops. Guide elements 26 define the vertical displaceability of supporting arms 22 relative to pick-up drum 15 and grain pan 14. Instead of compressing rollers 3, 4, it is also possible to use bar-type compressing devices or plate-type compressing devices with compressing bars. Compressing plate 23 and bar grate 24 can also be designed as a roller-type compressing device and/or a bar-type compressing device and/or a plate-type compressing device with compressing bars.

Upper compressing roller 4 is provided with auger turns—which are not shown in FIG. 1—on the particular end. A driven conveyor auger 27 which serves as a conveying device is located downstream of upper compressing roller 4 in crop-material flow. Conveyor auger 27 is fixedly and hingedly mounted on side parts—which are not shown here—of pickup 2 somewhat above tub-shaped grain pan 14. Conveyor auger 27 compresses crop material 6 from the pick-up width of pickup 2 to the width of intake rollers 8. The crop material is conveyed by guidance elements 28 mounted on conveyor auger 27 below roller core 30 and transferred to intake rollers 8.

FIG. 2 shows a top view of pickup 2 shown in FIG. 1. A compressing roller 3, 4 is located on supporting segments 20 and on supporting arms 22. Compressing roller 3 in the front—as viewed in the direction of travel 7—is located outside the range of action of pick-up drum 15, and abutting compressing roller 4 is located within the range of action of pick-up drum 15. Advantageously, compressing rollers 3, 4 are movable—relative to each other and decoupled from each other—within the range of rotation limited by guide elements 25, 26 and shown in FIG. 1. This advantageously enables the conveyance and precompression of crop material 6 to be maintained even when a compressing roller 3, 4 must relinquish its optimal position for conveying and compressing crop material. Every compressing roller 3, 4 can therefore adapt itself to the crop-material conditions in accordance with its task. To prevent crop-material jams caused by uncovered compressing regions in the successive operation of compressing devices 3, 4, 23, 24, in particular compressing rollers 3, 4, the intermediate region between two compressing rollers 3, 4 is covered with a compressing plate 23.

Upper compressing roller 4 is followed by a compressing device 24 with bars which point toward discharge side of pickup 2. Inventive compressing roller 3, which serves to compress crop material 6 against ground 5, has a profile which extends across the length of compressing roller 3 and which includes several radially projecting segments 31. When pickup 2 makes several motions, crop material 6 moves in direction of travel 7 below compressing rollers 3, 4 along material-flow lines 32, 33, 34 shown and, upon contact with crop material 6 and via its profiling, sets them in rotational motion. Material-guidance elements in the form of auger windings 35 are mounted circumferentially on the rear compressing roller 4 on the side of compressing roller 4 facing particular supporting arm 22.

Auger windings 35 extend symmetrically from supporting arms 22 toward the middle of pickup 2. Auger windings 35 are designed such that, when compressing roller 4 is set into rotation by crop material 6, this brings about a conveyance of crop material 6 toward the middle of pickup 2, and crop material 6 simultaneously undergoes precompression against pick-up drum 15. According to the present invention, compressing device 3, 4, 23, 24 is provided with at least one actuator 18, such as a lifting cylinder, for controlling the bearing pressure of at least one compressing element 3 on crop material 6. It is also feasible that the bearing pressure can be controlled as a function of pressure sensors, which are known per se and are not shown here. This advantageously results in a precompression of crop material 6 adapted to the crop-material properties to attain a continual crop-material flow through pickup 2. As such, operation of pick-up device 1 is made easier for the operator.

A drive connection can be provided between individual compressing rollers 3, 4 to improve the transverse conveyance of crop material 6 inside pickup 2. Depending on the design of this drive connection, known chain, V-belt, or toothed gear drive connections can be used. At particular bearing points 36 of compressing rollers 3, 4 a sprocket wheel can be non-rotatably mounted coaxially on particular shaft, and a mutual drive by a chain which encloses the sprocket wheels can be established. It is also feasible that several compressing rollers 3, 4 drive at least one compressing roller 3, 4 via a drive connection. Furthermore, only one part of compressing rollers 3, 4 can be designed with a common drive. Via the drive, the effect of material-guidance elements 38 on compressing roller 4 is advantageously increased.

To reduce crop-material losses and to actively convey crop material 6 through pickup 2, at least one compressing roller 3, 4 can also be actively driven by a drive device. For example, an electric-motor, hydraulic or mechanical drive known per se is suited for this purpose. It can drive a single compressing roller 3, 4, or it can engage in a drive connection at least between two compressing rollers 3, 4. The mode of operation of first and at least one further compressing roller 3, 4 is improved as a result, and it can be actively interfered with via a possible control of the drive speed, e.g., as a function of the ground speed, by speed sensors known per se or the circumferential speed of compressing roller 3, 4. The compression of the crop material can therefore be actively influenced by controlling compressing rollers 3, 4. A high circumferential speed of the compressing roller loosens the crop material and a low circumferential speed of the compressing roller compresses the crop material.

Crop material 6 leaves the compressing region of compressing roller 4 in a material-flow direction 9 indicated via material-flow lines 32, 33, 34. Downstream conveying device 27—which is provided with conveyor auger turns 35 in certain areas—then continues to compress the crop material until it has the width of intake roller 8. The entire quantity of crop material is then guided under intake rollers 8 by conveying elements 28 mounted on roller core 30 of conveying device 27.

It is within the scope of abilities of one skilled in the art to modify the compression device of a pickup described in a manner not described, or to use it in applications other than those shown here, to obtain the effects described.

It will be understood that each of the elements described above, or two or more together, may also find a useful application in other types of constructions differing from the type described above.

While the invention has been illustrated and described as embodied in a pick-up device for agricultural harvesting machines, it is not intended to be limited to the details shown, since various modifications and structural changes may be made without departing in any way from the spirit of the present invention.

Without further analysis, the foregoing will so fully reveal the gist of the present invention that others can, be applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A pick-up device for agricultural harvesting machines for picking up crop material lying on a ground, comprising a pick-up drum which has tines; means selected from the group consisting of conveyor means, cutting means, and both and located adjacent to said pick-up drum in a direction of material flow; a compressing device extending transversely to a direction of travel of the agricultural harvesting machine within a range of action of said pick-up drum, said compressing device including a first compressing element in the range of action of said pick-up drum and at least one further compressing device outside of the range of action of said pick-up drum, and a further compressing element causing the crop material to be precompressed onto the ground.

2. A pick-up device as defined in claim 1, wherein said compression device is a device selected from the group consisting of a bar-shaped compressing device, a plate-shaped compressing device, and a roller-shaped compressing device.

3. A pick-up device as defined in claim 1, wherein said first compressing element is configured so as to provide a compression of the crop material against said pick-up drum.

4. A pick-up device as defined in claim 1, wherein said compressing elements are movable relative to one another within a specified range of rotation.

5. A pick-up device as defined in claim 4; and further comprising a guide element which limits a rotation movement of said compressing elements and includes at least one lower end stub and one upper end stub.

6. A pick-up device as defined in claim 1, wherein said compressing elements are configured so that a bearing pressure applied by said compressing elements is separately adjustable.

7. A pick-up device as defined in claim 1, wherein said compressing device is provided with at least one actuator for changing a bearing pressure applied by at least one of said compressing elements on the crop material.

8. A pick-up device as defined in claim 1, wherein said compressing device is configured so that a bearing pressure applied by at least one of said compressing elements is controllable.

9. A pick-up device as defined in claim 1; and further comprising a supporting frame, at least one of said compressing elements being pivotally connected with said supporting frame and compressing the crop material against the ground, while another of said compressing elements is movable relative to said one compressing element and compresses the crop material against said pick-up drum.

10. A pick-up device as defined in claim 1; and further comprising at least one material-guidance element assigned to at least one of said compressing elements and formed as a member selected from the group consisting of a bar, a plate, and an auger turn.

11. A pick-up device as defined in claim 10; and further comprising a further material-guidance element which substantially covers open spaces at a location selected from the group consisting of in front of said compressing elements and between said compressing elements and configured as a member selected from the group consisting of a guide plate and a bar plate.

12. A pick-up device as defined in claim 1, wherein at least one of said compressing elements of said compressing device includes a material-guidance element, said compressing elements being configured as compressing rollers with different diameters at least in certain areas.

13. A pick-up device as defined in claim 1, wherein said compressing device is configured so as to bring about a conveyance of the crop material transversely the material flow direction at least in certain areas.

14. A pick-up device as defined in claim 1, wherein at least one of said compressing elements is actively driven; and further comprising means for actually driving said at least one of said compressing elements.

15. A pick-up device as defined in claim 1, wherein said first and second compressing elements are configured as compressing rollers arranged so that at least one of said compressing rollers drives said other compressing roller.

16. A pick-up device as defined in claim 1, wherein said compressing element which is configured to compress the crop material against the ground is fixable in an upper end position.

17. A pick-up device as defined in claim 1, wherein said pick-up device is configured as a pick-up.
